(19) United States
(12) Patent Application Publication
(10) Pub. No.: US 2014/0047391 A1
(43) Pub. Date: Feb. 13, 2014

(54) System and Method for Communicating with Non-Verbal Persons

(71) Applicant: Ian MacInnes, Pearland, TX (US)

(72) Inventor: Ian MacInnes, Pearland, TX (US)

(21) Appl. No.: 13/571,711

(22) Filed: Aug. 10, 2012

(51) Int. Cl. G06F 3/048

(52) U.S. Cl. 715/841

(57) ABSTRACT

An improved method for controlling menu content on an electronic communication device. In one embodiment, the method for controlling menu content can comprise storing in a memory one or more selections and a context, associating each of the context with one or more of the selections, comparing the context to a condition, determining the condition is outside a parameter, and removing each selection associated with the context from a menu hierarchy. In this method, the condition is relating to an electronic device. The context can comprise the parameter. The menu hierarchy is displayable on a screen of the electronic device.

### BACKGROUND

This disclosure relates to a system and method for controlling menu content on an electronic communication device.

Methods for communicating with a non-verbal individual have been developed to aid a non-verbal person in expressing his own thoughts, emotions, and needs. Through the help of technology, several communication and electronic devices can now be used to help non-verbal individuals, such as persons who are autistic, deaf, mute, or afflicted by stroke, to communicate.

In the past, applications and devices have been programmatically designed to display various images, icons, or symbols that can represent an object, thought, need, or emotion. Such application can allow a non-verbal individual to navigate and select an image that can translate the message he wants to convey to a specific person. As an example scenario, a communication device can display a main menu that comprises categories, such as, toys, people, and feelings. The non-verbal person or user can select the food category to indicate the kind of food he wanted to eat. After selecting the food category, the communication device can display various images of food accessible to the user. However, food can cover a wide array of choices. Moreover, many of the available food selections can be irrelevant or unavailable at a specific time or place. Thus, it can be very frustrating and inconvenient for a user to search from several images to find the specific food he wants, only to find that it is unavailable.

As such, it would be useful to have an improved method for communicating with non-verbal persons.

### SUMMARY

An improved method for communicating with non-verbal persons is described herein. In one embodiment, the method for controlling menu content can comprise storing in a memory one or more selections and a context, associating each of the context with one or more of the selections, comparing the context to a condition, determining the condition is outside a parameter, and removing each selection associated with the context from a menu hierarchy. In this method, the condition is relating to an electronic device. The context can comprise the parameter. The menu hierarchy is displayable on a screen of the electronic device.

In another embodiment, a method can comprise can comprise storing in a server memory a profile, associating each of the contexts with one or more of a selection within the profile, comparing the context to a condition, determining the condition is within a parameter, and adding each selection associated with the context from a menu hierarchy. In this embodiment, the condition is relating to an electronic device. The profile can comprise the selections and the context. The context can comprise the parameter. The menu hierarchy is displayable on a screen of the electronic device.

Lastly, in one embodiment, a system can comprise a computer readable storage medium having a computer readable program code embodied therein. The computer readable program code can be adapted to be executed to implement the abovementioned methods.

### BRIEF DESCRIPTION OF THE DRAWINGS

FIG. 1 illustrates a communication network system.

FIG. 2A illustrates an embodiment of an electronic device.

FIG. 2B illustrates an internal hardware of an electronic device.

FIG. 2C illustrates a device memory.

FIG. 3 illustrates a schematic diagram of a server.

FIG. 4A illustrates a server data store.

FIG. 4B illustrates a profile.

FIG. 4C illustrates a selection record.

FIG. 5A illustrates a screen displaying a main menu page.

FIG. 5B illustrates a screen displaying selections.

FIG. 5B illustrates a graphical user interface of sub-menu displayed in screen.

FIG. 5C illustrates a graphical user interface of context page.

FIG. 5D illustrates a graphical user interface that allows user to manipulate contexts.

FIG. 6 illustrates an exemplary method populating selections based within a parameter of contexts.

FIG. 7 illustrates another exemplary method populating selections based within a parameter of contexts.

### DETAILED DESCRIPTION

Described herein is a improved method for communicating with non-verbal persons. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

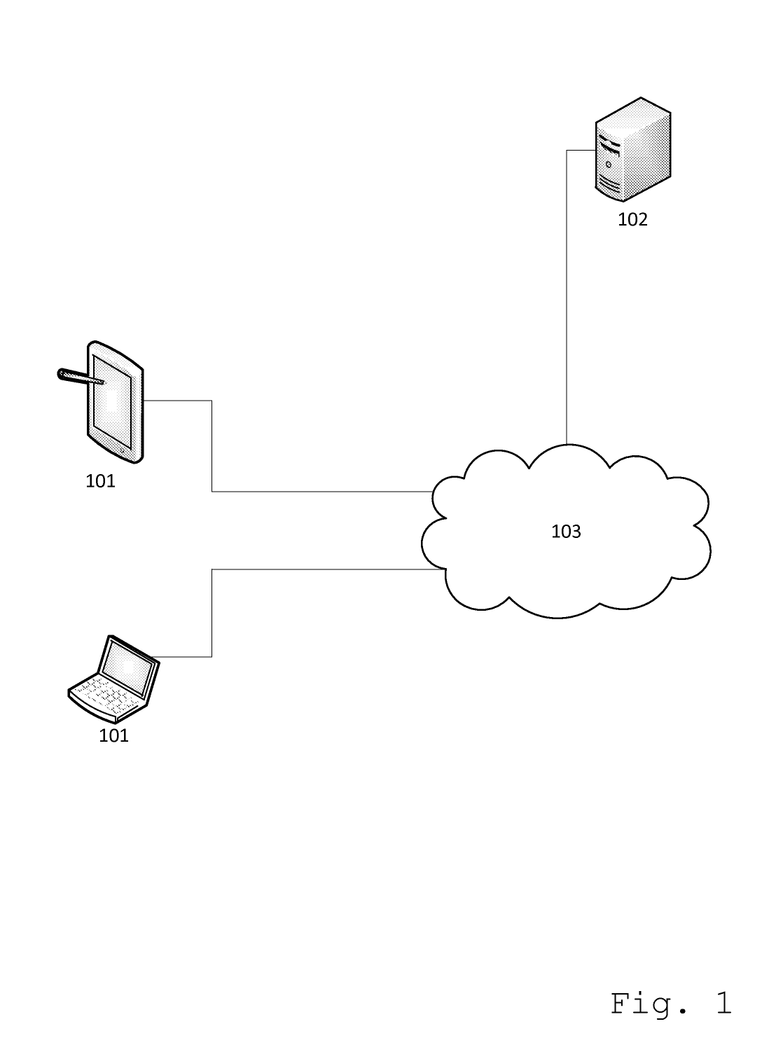

FIG. 1 illustrates a communication network system comprising one or more electronic device 101, one or more server 102 connected via a network 103. Electronic device 101 can be any equipment capable of carrying out arithmetic and logic operations. Electronic device 101 can receive, store and send out data information through network 103. Electronic device 101 can include, but is not limited to, a mobile phone, a laptop, a personal digital assistant (PDA), and/or a tablet. In an embodiment wherein electronic device 101 is a mobile device, electronic device 101 can be handheld equipment used for communicating. Electronic device 101 can use mobile phone tracking technology that uses radio signals between several radio towers, and/or Global Positioning System (GPS) to determine current time and location of said electronic device 101.

Server 102 can provide and perform computational tasks across network 103. Server 102 can send and receive data to and from electronic device 101. Moreover, server 102 can contain data from individuals, public and/or private establishments, such as home, schools, hospitals, and restaurants. Network 103 can be a wide area network (WAN), or a combination of local area network (LAN), and/or piconets. Network 103 can be hard-wired, wireless, or a combination of both. A LAN can be a network within a single business while WAN can be an Internet.

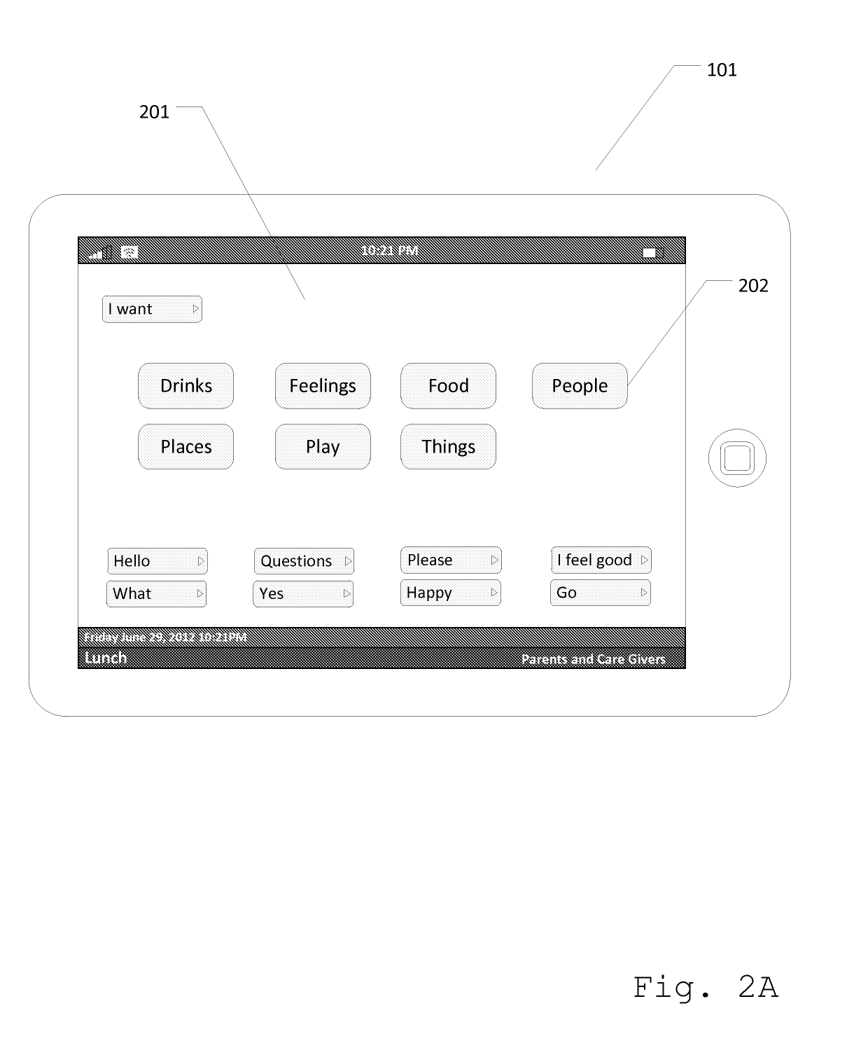

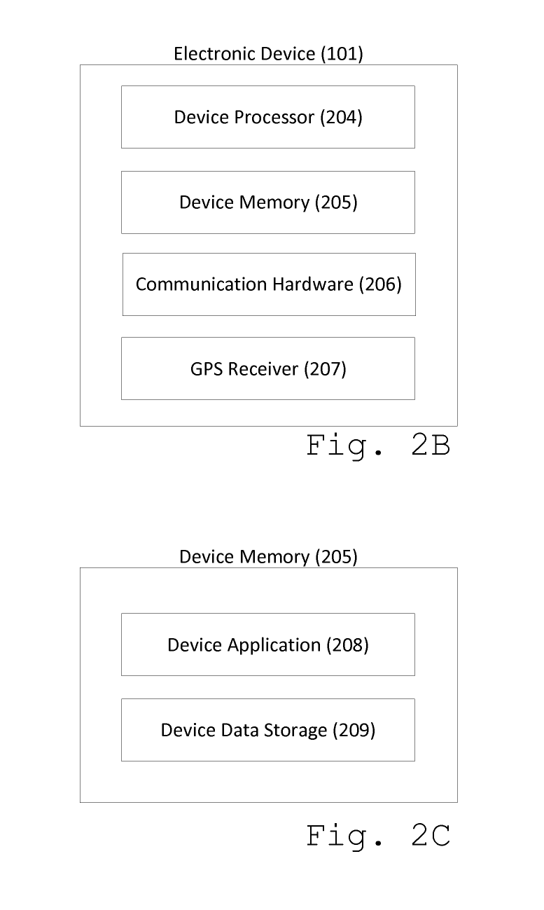

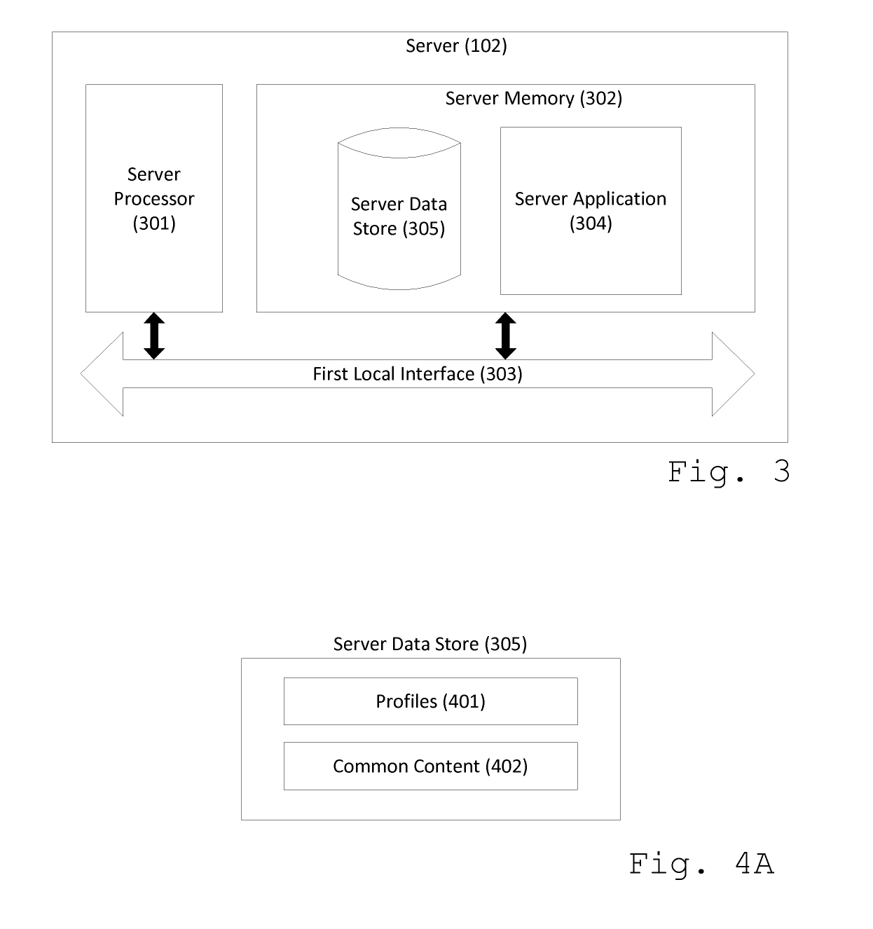

FIG. 2A illustrates an embodiment of an electronic device 101. Electronic device 101 can comprise a screen 201. Input devices can include keypad, buttons, track balls, joysticks, or scroll wheels. Keypad can comprise a plurality of physical buttons comprising alphanumeric characters and/or symbols. However, in an embodiment where screen 201 is a touch screen, keypad can be represented virtually on screen 201. Keypad can be used to customize, and add an input data 202 in electronic device 101. In an embodiment wherein electronic device 101 can be a touch screen, text, pictures, and/or symbols can be buttons that, upon being pressed, capture such pressing as input data 202 from screen 201. Moreover, input data 202 can be the selection made by the user of electronic device 101.

FIG. 2B illustrates internal hardware of an electronic device 101 comprising a device processor 204, a device memory 205, communication hardware 206, and a GPS receiver 207. Input data 202 from screen 201 can be sent to device processor 204. Device processor 204 can be a device that executes programs stored in device memory 205. Device memory 205 can be a physical device used to store programs and/or data. Communication hardware 206 can include a network transport processor for packetizing data, communication ports for wired communication, or an antenna for wireless communication. Processes can include storing input data 202 to device memory 205, verifying input data 202 is valid and conforms to preset standards, or ensuring all required data. Input data 202 can be sent to communication hardware 206 for communication over network 103. GPS receiver 207 determines location of electronic device 101 using methods commonly known in the art.

FIG. 2C illustrates device memory 205 comprising a device application 208 and a device data storage 209. Device application 208 can reside and perform logical functions within device memory 205. Device application 208 can receive and transmit sets of instructions and data information across network 103. Device data storage 209 can be a component in device memory 205 that can be used to retain digital data. Further, device processor 204 can perform processes on the data according to a device application 208 stored in device memory 205. Processes can include storing input data 202 in device data storage 209. Input data 202 can be sent to communication hardware 206 and then over network 103.

FIG. 3 illustrates a schematic diagram of server 102 according to an embodiment of the present disclosure. Server 102 can comprise a server processor 301, and a first local interface 303. First local interface 303 can be a program that controls a display for the user, which can allow user to view and/or interact with server 102. Server 102 can be a processing unit that performs a set of instructions stored within server memory 302. Server memory 302 can comprise a server application 304, and a server data store 305. Server application 304 can be a program providing logic for server 102. Server data store 305 can be collections of data accessible through server application 304. Further, server application 304 can perform functions such as adding, transferring, and retrieving information on server data store 305 using first local interface 303. In one embodiment, electronic device 101 and server 102 can be the same device or set of devices.

Server 102 includes at least one processor circuit, for example, having server processor 301 and server memory 302, both of which are coupled to first local interface 303. To this end, the server 102 can comprise, for example, at least one server, computer or like device. First local interface 303 can comprise, for example, a data bus with an accompanying address/control bus or other bus structure as can be appreciated.

Both data and several components that are executable by server processor 301 are stored in server memory 302. In particular, server application 304 and, potentially, other applications are stored in the server memory 302 and executable by server processor 301. Also, server data store 305 and other data can be stored in server memory 302. In addition, an operating system can be stored in server memory 302 and executable by server processor 301.

Other applications can be stored in server memory 302 and executable by server processor 301. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in server memory 302 and can be executable by server processor 301. In this respect, the term “executable” can mean a program file that is in a form that can ultimately be run by server processor 301. Examples of executable programs can include a compiled program that can be translated into machine code in a format that can be loaded into a random access portion of server memory 302 and run by server processor 301, source code that can be expressed in proper format such as object code that is capable of being loaded into a random access portion of server memory 302 and executed by server processor 301, or source code that can be interpreted by another executable program to generate instructions in a random access portion of server memory 302 to be executed by server processor 301, etc. An executable program can be stored in any portion or component of server memory 302 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

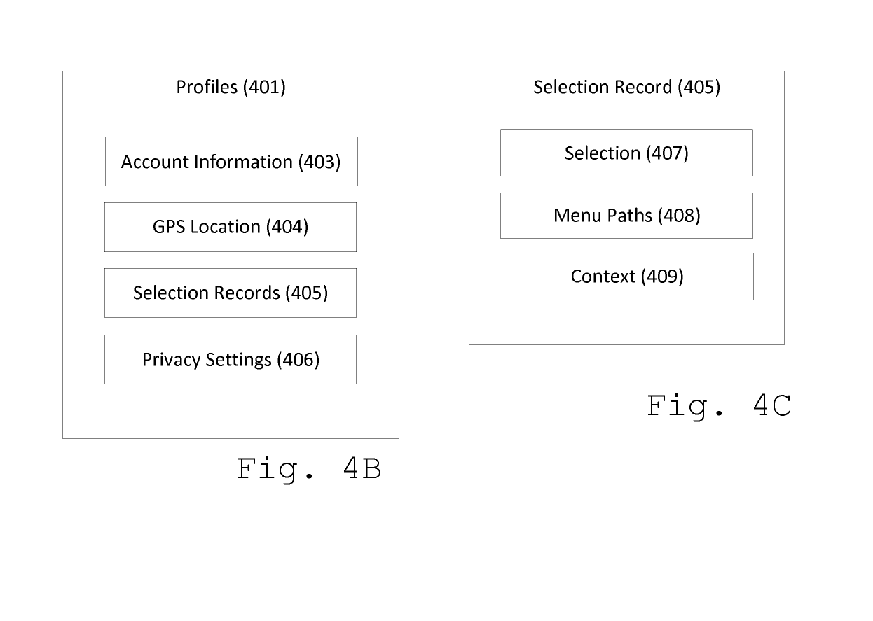

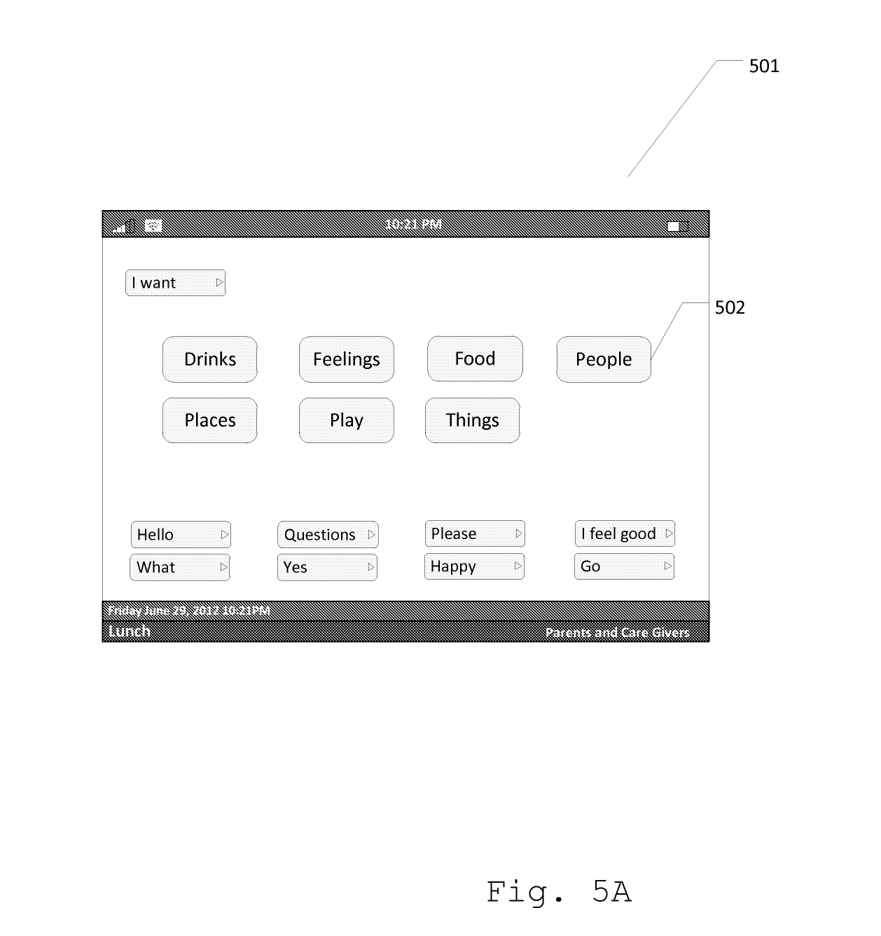

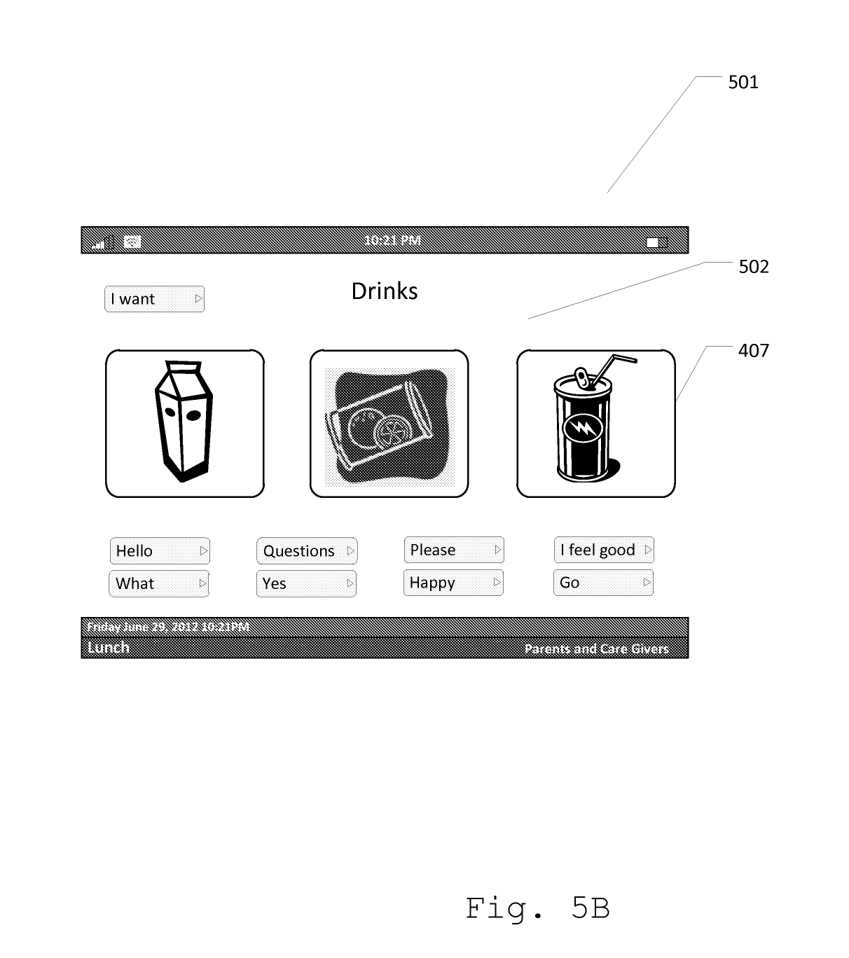

FIG. 4A illustrates a server data store 305 comprising one or more profiles 401 and common content 402. Profile 401 can be a set of unique accounts. Electronic device 101 can be used to create a profile 401. In one embodiment, profiles 401 and common content 402 can be stored in server 102. In another embodiment, profiles 401 and common content 402 can be stored locally or within electronic device 101. Common content 402 can be a collection of content information such as images, categories, or menus that can be shared through network 103, and used by different electronic devices 101 and profiles.

FIG. 4B illustrates profile 401 that can comprise account information 403, a GPS location 404, one or more selection records 405, and one or more privacy settings 406. Account information 403 can comprise information on a user such as a name, username, password, email address, and/or billing information. While creating a profile 401, a user can provide account information 403. To access server application 304, a user can provide account information 403, such as a username and password. In an embodiment wherein a portion of profile 401 can be in electronic device 101, the account information 403 can be verified through server 102.

GPS location 404 can be the location coordinates of electronic device 101. Depending on embodiment, device application 208 can either store GPS location 404 in device data storage 209 or transmit GPS location 404 to server application 304 for storage in server data store 305, in profile 401. In another embodiment, GPS location 404 can be stored in both device memory 205 and server memory 302.

Selection record 405 can comprise a collection of data related to what data is shown on screens and at what times. Privacy settings 406 can be a type of visibility configuration defined for set of selection records 405. Privacy settings 406 can determine the selection records 405 that can be available to the public. As a non-limiting example, privacy settings 406 can either be set to public or private. Privacy settings 406 set as “private” can be a configured for personal use. In such setting, selection records 405 can only be visible to a user logged on to profile 401 comprising selection record 405 or, in another embodiment, to a user using electronic device 101 that selection record 405 is stored on or to the user of electronic device 101.

Privacy settings 406 set as “public” can be configured to be available to the public. In such setting, public selection records 405 can be retrieved by every individual using any electronic device 101. As an example, privacy settings 406 set to “public” can include selection records 405 for establishments that can include but are not limited to restaurants, hospitals, schools, supermarkets, or parks. Further, selection records 405 with privacy settings 406 set to public can be limited by a geographic context 409. This ensures that public selection records are not accessible on electronic devices 101 in all places. In such embodiment, selection records 405 for public records can only be viewed when electronic device 101 is at the relevant public location. In one embodiment, privacy setting 406 relates to profile 401 and all selection records 405 within it. In another embodiment, privacy setting 406 can exist for each selection record 405. In such embodiment, one selection record 405 within a profile may be public while another selection record 405 in profile 401 can be private.

Further, in one embodiment selection records 405 for private use can be available or stored within electronic device 101. In such embodiment, private selection records 405 can be retrieved locally, and be displayed for electronic device 101. In another embodiment, selection records 405 for private use can be stored in server 102. As such, electronic devices 101 can communicate with server 102 to retrieve private selection records 405 whenever electronic device 101 is connected to network 103. By their nature, public selection records 405 must be on the server, hower, such selection records 405 can be pushed down to various electronic devices 101 to be available when electronic device 101 is not connected to server 102. In such embodiment, electronic device 101 can regularly run an update to synchronize electronic device 101 with the updates for all or selected public selection records 405 in server 102.

FIG. 4C illustrates selection record 405. Profile 401 can comprise many selection records 405. Each selection record 405 can comprise a selection 407, one or more menu paths 408, and one or more contexts 409. Selection 407 can comprise can be displayed on screen 201 as text, pictures, and/or symbols. Selection 407 can be an expression or a folder comprising expressions and/or folders. Expressions can include, but are not limited to, statements, drinks, feelings, food, people, places, and/or play activities. For example, selection 407 can be the word “banana” or a picture of a banana. User can select selection 407 to communicate to a third party that he wants a banana. Menu path 408 can tell server application 304 or device application 208 where to display selection 407 in a navigable menu hierarchy or folders on screen 201. In one embodiment, a folder can be a category that selection 407 fits into, such as “food.” In another embodiment, menu path 408 can have many levels of folders such as “food\fruits.” In one embodiment, all or part of menu path can be stored separately in profile 401 as a “menu hierarchy” that relates the placement of files and/or expressions to each other. Selection record 405 can comprise no contexts 409 or any number of contexts 409. Context 409 is a limitation on when, where, or for whom a selection 407 will be available for a user to choose.

For example, a user may only want to see selections 407 having to do with breakfast. In such scenario, context 409 can be created for breakfast items using a time period such as 6 AM to 11 AM, or a time and a parameter such as “within two hours of the time.” As such, the time period can be the basis of context 409 to bound selections 407. Using a time available to electronic device 101 or server 102, device application 208 or server application 304 can either display selection 407 or not display selection 407 based on the time. In another example, a user may have a toy that is at his home that is not available at school. In such example, selection 407 relating to the toy may only be displayed when user and the electronic device 101 are at within a predetermined distance from his home. In such scenario, device can be dependent on the time and location transmitted by electronic device 101. As a result, choices displayed on screen 201 can vary and change depending on the place and time of the day electronic device 101 is used.

Selection record 405 is one example of how selection 407, menu path 408, and contexts 409 can be associated in a computing environment; however such example should not be limiting. It is not necessary that selection 407, menu path 408, and contexts 409 be stored together. It is only necessary that they be associated with each other in any way that a computer can associate data. As such, the above examples should not be limiting.

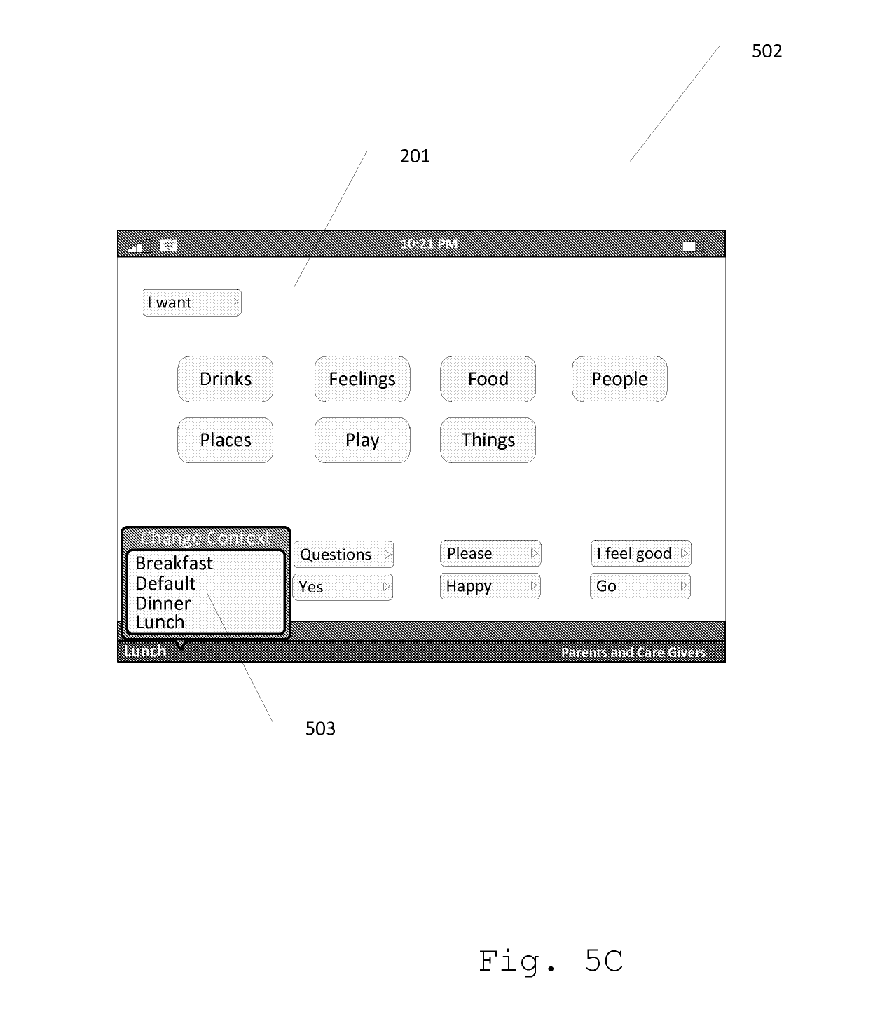

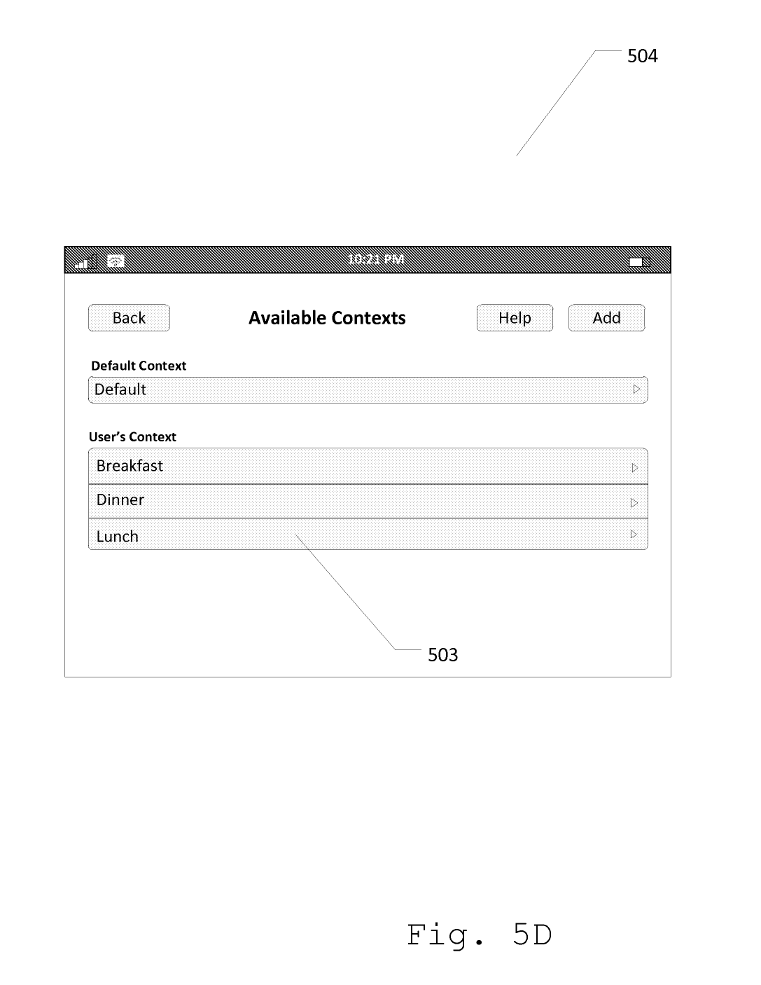

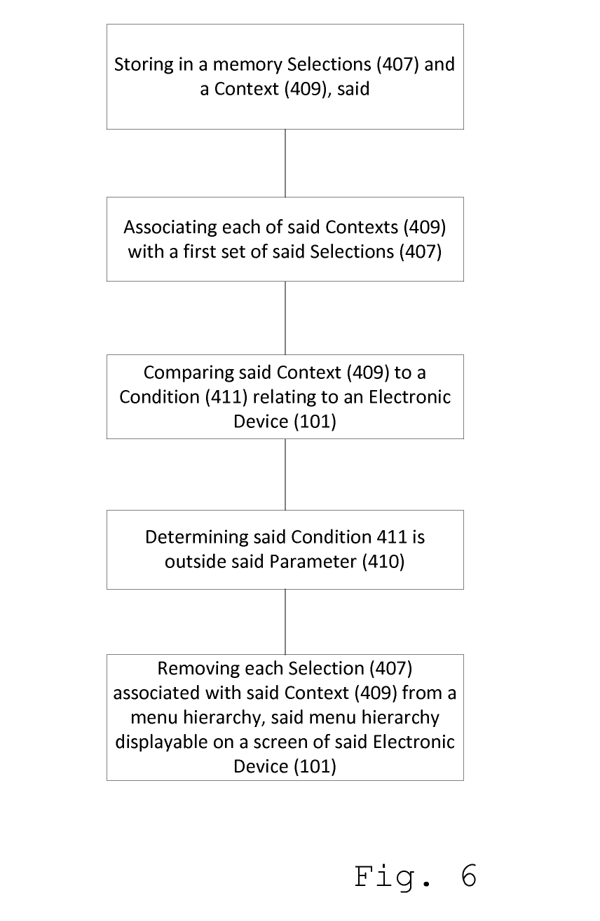

FIG. 5A illustrates a graphical user interface of main application page 501 containing main menu 502 displayed on screen 201. In one embodiment, main menu 502 can be a default set of selections 407 programmed in device application 208 or server application 304. Main menu 502 can comprise selections 407 that are preset to electronic device 101. In such embodiment, electronic device 101 can prohibit creation, modification, and deletion of some or all selections 407 in main menu 502. In another embodiment, main menu 502 can be user-defined. In such embodiment, a user can create, modify, and/or delete selections 407 in main menu 502. Within each folder of main menu 502 can be more selections 407, viewable as a menu on screen 201.

FIG. 5B illustrates selections within a folder of main menu 502. For main menu 502 and each subsequent menu, each selection 407 can be displayed or not displayed depending on contexts associated with selection 407, as described above. The set of menus described herein together make up a menu hierarchy that is viewable and navigable in portions on screen 201.

FIG. 5C illustrates a graphical user interface of context override 503 displayed in screen 201. Main menu 502 can comprise no context override 503 or one or more context override 503. Selecting a button from main menu 502 can display context override 503. In one embodiment, context override 503 can be displayed as a new page. In another embodiment, context override 503 can be displayed on the same main application page 501 through a dialog box, pop up, or menu.

FIG. 5D illustrates a graphical user interface that allows user to manipulate contexts 409. In one embodiment, context 409 can be created, modified, and/or deleted. In such embodiment, user can assign contexts to one or more selections 407. In another embodiment, wherein contexts are predetermined by server application or device application, user can select to use preset or defaults defined on electronic device 101. In another embodiment, user has an option to define contexts 409 that can be available for context override 503.

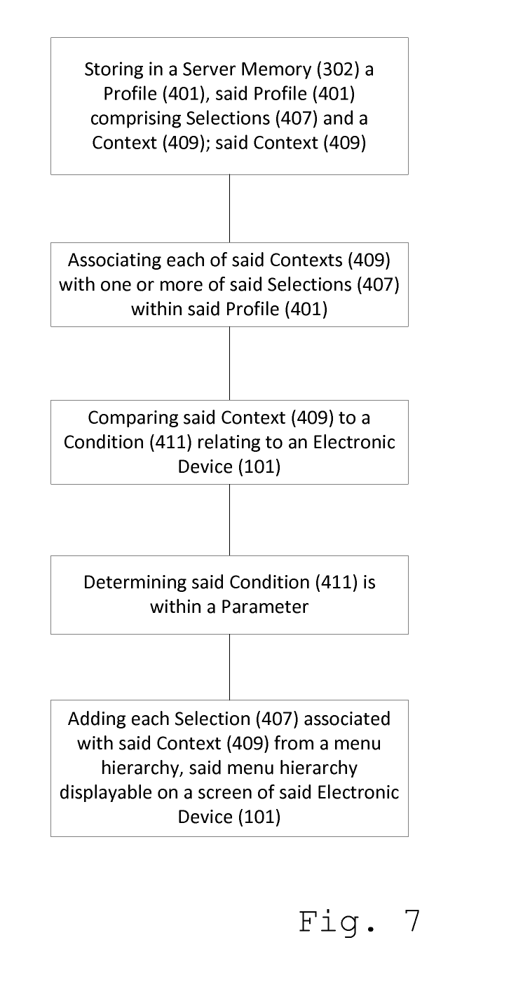

FIG. 6 illustrates an exemplary method for communicating with non-verbal persons. One or more selections 407 and context 409 can be stored in a memory. In one embodiment, selections 407 and contexts 409 can be stored in a device memory 205 of electronic device 101. As such, electronic device 101 can retrieve selection 407 locally and does not need to connect via network 103 to retrieve selections 407 from a server. Context 409 can be compared with condition 411 relating to electronic device 101. GPS location 404 obtained from GPS receiver 207 of electronic device 101 can be used as condition 411. Electronic device 101 can determine the condition 411 outside the parameters 410 and remove each selection 407 that can be associated with context 409 from the menu hierarchy. The menu hierarchy can be displayed on screen 201 of electronic device 101. Moreover, selections 407 that were not removed can be displayed under the applicable menu path 408.

In one embodiment, context 409 can be a location. In such embodiment parameter can be a predetermined distance. If electronic device is not within the predetermined distance from the location, then selections 407 are not within the menu hierarchy and therefore not displayable on screen 201.

In another embodiment, context can be a time or time period. In such embodiment, parameter can be a window or other matching criteria, such as within the time period, outside the time priod, or within an hour of the time period, for example. If the time as known by electronic device 101 or server 102 communicating is not within the parameters relating to the time period, then selections 407 are not within the menu hierarchy and therefore not displayable on screen 201.

In another embodiment, context can be a user of electronic device. In such embodiment, parameter can be an exact match requirement. For example, many users may have access to electronic device 101. Device application 208 can be programmed to allow different users to select their name to tell device application 101 who they are. If the name selected does not match the name in context, then selections 407 are not within the menu hierarchy and therefore not displayable on screen 201.

FIG. 7 illustrates an exemplary method for communicating with non-verbal persons. Profile 401 can be stored in a server memory. The profile can comprise selections 407 and a context 408. Context 408 can be associated with one or more selections within the profile. Context 408 can be compared to a condition relating to the device, and it can be determined if the condition is within a parameter. If the condition is within a parameter, then each selection associated with the context can be added to a menu hierarchy. The menu hierarchy can be displayable on a screen of the electronic device.

In one embodiment, context 409 can be a location. In such embodiment parameter can be a predetermined distance. If electronic device is within the predetermined distance from the location, then selections 407 can be within the menu hierarchy and therefore displayable on screen 201.

In another embodiment, context can be a time or time period. In such embodiment, parameter can be a window or other matching criteria, such as within the time period, outside the time priod, or within an hour of the time period, for example. If the time as known by electronic device 101 or server 102 communicating within the parameters relating to the time period, then selections 407 are within the menu hierarchy and therefore displayable on screen 201.

In another embodiment, context can be a user of electronic device. In such embodiment, parameter can be an exact match requirement. In such embodiment, many users may have access to device. Device application can be programmed to allow different users to select their name to tell device application who they are. If the name selected does not match name in context, then selections 407 are not within the menu hierarchy and therefore not displayable on screen 201.

In the various embodiments listed above, parameter can either be user defined, chosen by device application 208 or server application 304, or can be an inherent programming aspect (such as string matching for a name) of either of the applications mentioned.

Server memory 302 can include both volatile and nonvolatile memory and data storage components. Volatile components do not retain data values upon loss of power. Nonvolatile components, on the other hand, retain data upon a loss of power. Thus, server memory 302 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, server processor 301 can represent multiple server processors 301. Likewise, server memory 302 can represent multiple server application memories 302 that operate in parallel processing circuits, respectively. In such a case, first local interface 303 can be an appropriate network, including network 103 that facilitates communication between any two of the multiple server processors 301, between any server processor 301 and any of the server memory 302, or between any two of the server memory 302, etc. First local interface 303 can comprise additional systems designed to coordinate this communication, including, but not limited to, performing load balancing. Server processor 301 can be of electrical or of some other available construction.

Although server application 304, and other various systems described herein can be embodied in software or code executed by general purpose hardware discussed above, server application 304 can also be embodied in dedicated hardware or a combination of software/general purpose hardware and dedicated hardware. If embodied in dedicated hardware, each server application 304 can be implemented as a circuit or state machine that employs a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIG. 6 and FIG. 7 show the functionality and operation of an implementation of portions of server application 304. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as server processor 301 in a computer system or other system. The machine code can be converted from the source code, etc. If embodied in hardware, each block can represent a circuit or a number of interconnected circuits to implement the specified logical function(s).

Although the flowcharts of FIG. 6 and FIG. 7 show a specific order of execution, the order of execution can differ from what is depicted. For example, the order of execution of two or more blocks can be rearranged relative to the order shown. Also, two or more blocks shown in succession in FIG. 6 can be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. All such variations are within the scope of the present disclosure.

Also, any logic or application described herein that comprises software or code, including server application 304, can be embodied in any computer-readable storage medium for use by or in connection with an instruction execution system such as, server processor 301 in a computer system or other system. The logic can comprise statements including instructions and declarations that can be fetched from the computer-readable storage medium and executed by the instruction execution system.

In the context of the present disclosure, a “computer-readable storage medium” can be any medium that can contain, store, or maintain the logic or application described herein for use by or in connection with the instruction execution system. The computer-readable storage medium can comprise any one of many physical media, such as electronic, magnetic, optical, electromagnetic, infrared, or semiconductor media. More specific examples of a suitable computer-readable storage medium can include, but are not limited to, magnetic tapes, magnetic floppy diskettes, magnetic hard drives, memory cards, solid-state drives, USB flash drives, or optical discs. Also, the computer-readable storage medium can be a random access memory (RAM), including static random access memory (SRAM), dynamic random access memory (DRAM) or magnetic random access memory (MRAM). In addition, the computer-readable storage medium can be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method for controlling menu content comprising
storing in a memory selections and a context;
associating said context with a first set of said selections;
comparing said context to a condition relating to an electronic device;
determining said condition is outside a parameter; and
removing each selection associated with said context from a menu hierarchy, said menu hierarchy displayable on a screen of said electronic device.

2. The method of claim 1 wherein said memory is a device memory within said electronic device;

3. The method of claim 1 wherein said memory is a server memory;

4. The method of claim 1 wherein said context relates to a location, further wherein said condition is a GPS location.

5. The method of claim 4 wherein said parameter is a predetermined distance from said location.

6. The method of claim 1 wherein said context relates to a time period and said condition relates to a clock time;

7. The method of claim 1 wherein said context relates to a user;

8. The method of claim 1 further comprising the step of storing in said memory a second context, said second context related to a second set of said selections.

9. A method for controlling menu content comprising
storing in a server memory a profile, said profile comprising selections and a context; said context comprising a parameter;
associating each of said contexts with one or more of said selections within said profile;
comparing said context to a condition relating to an electronic device;
determining said condition is within said parameter; and
adding each selection associated with said context from a menu hierarchy, said menu hierarchy displayable on a screen of said electronic device.

10. The method of claim 9, further comprising the step of determining said profile comprises a privacy setting that is set to public.

11. The method of claim 9 wherein said memory is a device memory within said electronic device;

12. The method of claim 9 wherein said memory is a server memory;

13. The method of claim 9 wherein said context relates to a location, further wherein said condition is a GPS location.

14. The method of claim 13 wherein said parameter is a predetermined distance from said location.

15. The method of claim 9 wherein said context relates to a time period and said condition relates to a clock time.

16. A computer readable storage medium having a computer readable program code embodied therein, wherein the computer readable program code is adapted to be executed to implement the method of claim 1.
